(19) United States
(12) Patent Application Publication
(10) Pub. No.: US 2004/0153473 A1
(43) Pub. Date: Aug. 5, 2004

(54) Method and system for synchronizing data in peer to peer networking environments

(76) Inventors: Norman Hutchinson, Richmond (CA); Joseph Wong, Vancouver (CA); Terry Coatta, Richmond (CA); James Wright, Vancouver (CA); Eddy Ma, Vancouver (CA)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/715,508

(22) Filed: Nov. 19, 2003

Related U.S. Application Data
(60) Provisional application No. 60/427,965, filed on Nov. 21, 2002.
(60) Provisional application No. 60/435,348, filed on Dec. 23, 2002.
(60) Provisional application No. 60/488,606, filed on Jul. 21, 2003.

(51) Int. Cl. G06F 17/00

(52) U.S. Cl. 707/104.1

(57) ABSTRACT

Methods and systems in accordance with the present invention provide a peer-to-peer replicated hierarchical data store that allows the synchronization of the contents of multiple data stores on a computer network without the use of a master data store. The synchronization of a replicated data store stored on multiple locations is provided even when there is constantly evolving set of communications partitions in the network. Each computer in the network may have its own representation of the replicated data store and may make changes to the data store independently without consulting a master authoritative date store or requiring a consensus among other computers with representations of the data store. Changes to the data store may be communicated to the other computers by broadcasting messages in a specified protocol to the computers having a representation of the replicated data store. The computers receive the messages and process their local representation of the data store according to a protocol described below. As such, each computer has a representation of the replicated database that is consistent with the representations of the data store on the other computers. This allows computers to make changes to the data store even when disconnected via a network partition.

### RELATED APPLICATIONS

This application is related to, and claims priority to the following U.S. Provisional Patent Applications which are incorporated by reference herein:

U.S. Provisional Patent Application Serial No. 60/427,965, filed on Nov. 21, 2002, entitled “System and Method for Enhancing Collaboration using Computers and Networking.”

U.S. Provisional Patent Application Serial No. 60/435,348, filed on Dec. 23, 2002, entitled “Method and System for Synchronizing Data in Ad Hoc Networking Environments.”

U.S. Provisional Patent Application Serial No. 60/488,606, filed on Jul. 21, 2003, entitled “System and Method for Enhancing Collaboration using Computers and Networking.”

This application is also related to the following U.S. patent applications which are incorporated by reference herein:

U.S. patent application Ser. No.______, filed on ______, entitled “Method and System for Synchronous and Asynchronous Note Timing in a System for Enhancing Collaboration Using Computers and Networking.”

U.S. patent application Ser. No.______, filed on ______, entitled “Method and System for Enhancing Collaboration Using Computers and Networking.”

U.S. patent application Ser. No.______, filed on ______, entitled “Method and System for Sending Questions, Answers and File Synchronously and Asynchronously in a System for Enhancing Collaboration Using Computers and Networking.”

### BACKGROUND

1. Field of the Invention

The present invention generally relates to data processing systems and data store synchronization. In particular, methods and systems in accordance with the present invention generally relate to synchronizing the content of multiple data stores on a computer network comprising a variable number of computers connected to each other.

2. Background

Conventional software systems provide for data to be stored in a coordinated manner on multiple computers. Such synchronization services ensure that the data accessed by any computer is the same as that accessed by any of the other computers. This can be accomplished by either: (1) centralized storage that stores data on a single computer and accesses the data from the remote computers, and (2) replicated storage that replicates data on each computer and employs transactions to ensure that changes to data are performed at the same time on each computer.

Centralized storage cannot be effectively used in environments where the set of interacting computers changes over time. In a centralized system, there is only one master computer or database, and accessing the data requires interacting with this computer. A master computer or database is one that is chosen as the authorative source for information. If the underlying network is partitioned and a given computer is not in the partition in which the master resides, then that computer has no access to the data.

This limitation of centralized storage typically means that the viable solution for variable networks with changing positions is some form of replicated storage. Conventional replication-based systems typically fall into two classes: (1) strong consistency systems which use atomic transactions to ensure consistent replication of data across a set of computers, and (2) weak consistency systems which allow replicas to be inconsistent with each for a limited period of time. Applications accessing the replicated data store in a weak consistency environment may see different values for the same data item.

Data replication systems that utilize strong consistency are inappropriate for use in environments where the set of replicas can vary significantly over short time periods and where replicas may become disconnected for protracted periods of time. If a replica becomes unavailable during replication, it can prevent or delay achieving consistency amongst the replicas. In addition, systems based on strong consistency generally require more resources and processing time than is acceptable for a system that must replicate data quickly and efficiently over a set of computers with varying processing or memory resources available.

Data replication systems that rely on weak consistency can operate effectively in the type of network environment under consideration. There are numerous conventional systems based on weak consistency (e.g., Grapevine, Bayou, Coda, refdbms). However, these conventional systems typically are not optimized for broadcast communications, are not bandwidth efficient and do not handle network partitioning well. It is therefore desirable to overcome these and related problems.

### SUMMARY

Methods and systems in accordance with the present invention provide a peer-to-peer replicated hierarchical data store that allows the synchronization of the contents of multiple data stores on a computer network without the use of a master data store. The synchronization of a replicated data store stored on multiple locations is provided even when there is constantly evolving set of communications partitions in the network. Each computer in the network may have its own representation of the replicated data store and may make changes to the data store independently without consulting a master authoritative data store or requiring a consensus among other computers with representations of the data store. Changes to the data store may be communicated to the other computers by broadcasting messages in a specified protocol to the computers having a representation of the replicated data store. The computers receive the messages and process their local representation of the data store according to a protocol described below. As such, each computer has a representation of the replicated database that is consistent with the representations of the data store on the other computers. This allows computers to make changes to the data store even when disconnected via a network partition.

A method in a data processing system having peer-to-peer replicated data stores is provided comprising the steps of receiving, by a first data store, a plurality of values sent from a plurality of other data stores, and updating a value in the first data store based on one or more of the received values for replication.

A method in a data processing system is provided having a first data store and a plurality of other data stores, the first data store having a plurality of entries, each entry having a value, the method comprising the steps of receiving by the first data store a plurality of values from the other data stores for one of the entries. The method further comprises determining by the first data store which of the values is an appropriate value for the one entry, and storing the appropriate value in the one entry to accomplish replication.

A data processing system is provided having peer-to-peer replicated data stores and comprising a memory comprising a program that receives, by a first data store, a plurality of values sent from a plurality of other data stores, and updates a value in the first data store based on one or more of the received values for replication. The data processing system further comprises a processor for running the program.

A data processing system is provided having a first data store and a plurality of other data stores, the first data store having a plurality of entries, each entry having a value. The data processing system comprises a memory comprising a program that receives by the first data store a plurality of values from the other data stores for one of the entries, determines by the first data store which of the values is an appropriate value for the one entry, and stores the appropriate value in the one entry to accomplish replication. The data processing system further comprises a processor for running the program.

### BRIEF DESCRIPTION OF THE DRAWINGS

The foregoing and other aspects in accordance with the present invention will become more apparent from the following description of examples and the accompanying drawings, which illustrate, by way of example only, principles in accordance with the present invention.

FIG. 1 depicts an exemplary system diagram of a data processing system in accordance with systems and methods consistent with the present invention.

FIG. 2 depicts a block diagram of representing an exemplary logical structure of a data store on a plurality of computers.

FIG. 3 depicts a more detailed block diagram of a computer system including software operating on the computers of FIG. 1.

FIG. 4 depicts a flowchart indicating steps in an exemplary method for changing a node in a local data store.

FIG. 5 depicts a flowchart indicating steps in an exemplary method for processing a received message.

FIG. 6 depicts a pictorial representation of a data item, called a “node,” stored in the data synchronization service implemented by the system of FIG. 3.

FIG. 7 depicts a flowchart indicating steps for synchronizing clocks.

### DETAILED DESCRIPTION

Overview

Methods and systems in accordance with the present invention provide a peer-to-peer replicated hierarchical data store that allows the synchronization of the contents of multiple data stores on a computer network without the use of a master data store. The synchronization of a replicated data store stored on multiple locations is provided even when there is constantly evolving set of communications partitions in the network. Each computer in the network may have its own representation of the replicated data store and may make changes to the data store independently without consulting a master authoritative data store or requiring a consensus among other computers with representations of the data store. Changes to the data store may be communicated to the other computers by broadcasting messages in a specified protocol to the computers having a representation of the replicated data store. The computers receive the messages and process their local representation of the data store according to a protocol described below. As such, each computer has a representation of the replicated database that is consistent with the representations of the data store on the other computers. This allows computers to make changes to the data store even when disconnected via a network partition.

In one implementation, the system operates by the individual computers making changes to their data stores and broadcasting messages according to a protocol that indicates those changes. When a computer receives a message, it processes the message and manages the data store according the protocol based on the received message. When conflicts arise between nodes on different data store, generally, the most recently updated node in the data store is used.

The replicated hierarchical data store (“RHDS”) has many potential applications in the general field of mobile computing. The RHDS may be used in conjunction with a synchronous real-time learning application which is described in further detail in U.S. patent application Ser. No.______ entitled “Method and System for Enhancing Collaboration Using Computers and Networking,” which was previously incorporated herein. In that application, the RHDS may be used to allow students and instructors with mobile computers (e.g., laptops) to interact with each other in a variety of ways. For example, the RHDS may be used to support the automatic determination of which users are present in an online activity. The software may achieve this by creating particular nodes within the RHDS when a participant joins or leaves an activity. In one implementation, the replication of these nodes to all other connected computers allows each computer to independently verify whether a given participant is online or not.

The RHDS can also be used to facilitate the discovery and configuration of resources in the local environment. For example, a printer could host the RHDS and write into it a series of nodes that described what sort of printer it was, what costs were associated with using it, and other such data. Upon connecting to that network, the RHDS running on a laptop computer would automatically receive all of this information. Application software could then query the contents of the local RHDS on the laptop and use that information to configure and access the printer. The network in question could potentially be a wireless network so that all of these interactions could occur without any physical connection between the laptop and the printer.

The software system described herein may, in one implementation, include several exemplary features:

1. One Message: The protocol described herein relies on the exchange of one type of message that carries a small amount of information. Additionally, participating computers are, in one implementation, required to retain no state other than the contents of the replicated data store itself. This makes the protocol suitable for implementation on computers with limited resources.

2. Idempotency: The messages exchanged by the protocol are idempotent meaning that they can be lost or duplicated by the network layer with no adverse effect on the operation of the system other than reduced performance. This makes the protocol viable in situations where network connectivity is poor.

3. Peer-to-Peer: In one implementation, there is no requirement at any point in the execution of the protocol for the existence of a special “master” or “primary” computer. Replication may be supported between arbitrary sets of communication computers, and the set of communicating computers can change over time.

4. Broadcast: The protocol described herein may operate in environments that support broadcast communications. Messages are broadcast and can used to perform pair-wise convergence by any receiver. This makes efficient use of available bandwidth since many replicas can be updated through the transmission of a single message.

5. No Infrastructure: A replica can be created on any computer simply by executing the replication protocol. No consensus on the current set of active replicas is required.

6. Transient Data: The protocol described herein supports both persistent and transient data. Transient data is replicated, but may be automatically removed from all replicas once it has expired. This makes it possible to aggressively replicate data without exhausting the resources of the participating computer systems.

System

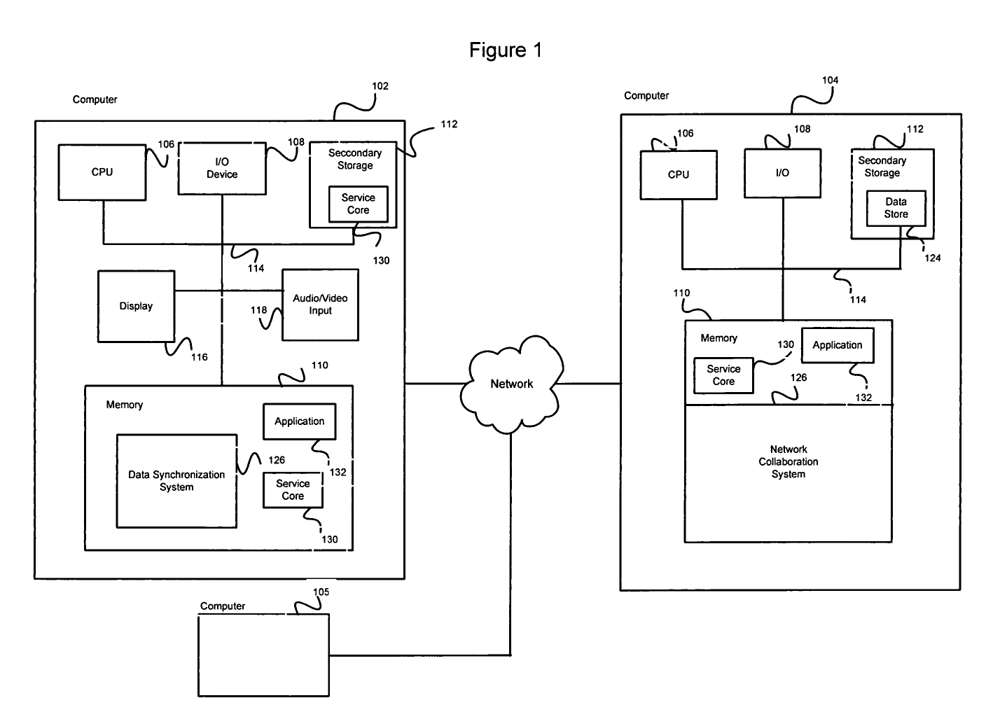

FIG. 1 depicts an exemplary data processing system suitable for use in accordance with methods and systems consistent with the present invention. Each computer 102, 104 and 105 has operating software operating thereon which aids in the replication and synchronization of information. FIG. 1 shows computers 102 and 105 connected to a network, which may be wired or wireless, and may be a LAN or WAN, and any of the computers may represent any kind of data processing computer, such as a general-purpose data processing computer, a personal computer, a plurality of interconnected data processing computers, video game console, clustered server, a mobile computing computer, a personal data organizer, a mobile communication computer including mobile telephones or similar computers. The computers 102, 104 and 105 may represent computers in a distributed environment, such as on the Internet. Computer 105 may have the same components as computers 102 and 104, although not shown. There may also be many more computers 102, 104 and 105 than shown on the figure.

A computer 102 includes a central processing unit (“CPU”) 106, an input-output (“I/O”) unit 108 such as a mouse or keyboard, or a graphical input computer such as a writing tablet, and a memory 110 such as a random access memory (“RAM”) or other dynamic storage computer for storing information and instructions to be executed by the CPU. The computer 102 also includes a secondary storage 112 such as a magnetic disk or optical disk that may communicate with each other via a bus 114 or other communication mechanism. The computer 102 may also include a display 116 such as such as a cathode ray tube (“CRT”) or LCD monitor, and an audio/video input 118 such as a webcam and/or microphone.

Although aspects of methods and systems consistent with the present invention are described as being stored in memory 110, one having skill in the art will appreciate that all or part of methods and systems consistent with the present invention may be stored on or read from other computer-readable media, such as secondary storage, like hard disks, floppy disks, and CD-ROM; a carrier wave received from a network such as the Internet; or other forms of ROM or RAM either currently known or later developed. Further, although specific components of the data processing system are described, one skilled in the art will appreciate that a data processing system suitable for use with methods, systems, and articles of manufacture consistent with the present invention may contain additional or different components. The computer 102 may include a human user or may include a user agent. The term “user” may refer to a human user, software, hardware or any other entity using the system. A user of a computer may include a student or an instructor in a class. The mechanism via which users access and modify information is a set of application programming interfaces (“API”) that provide programmatic access to the replicated hierarchical data store 124 in accordance with the description discussed below. As shown, the memory 110 in the computer 102 may include a data synchronization system 128, a service core 130 and applications 132 which are discussed further below. Although only one application 132 is shown, any number of applications may be used. Additionally, although shown on the computer 102 in the memory 110, these components may reside elsewhere, such as in the secondary storage 112, or on another computer, such as another computer 102. Furthermore, these components may be hardware or software whereas embodiments in accordance with the present invention are not limited to any specific combination of hardware and/or software. As discussed below, the secondary storage 112 may include a replicated hierarchical data store 124.

FIG. 1 also depicts a computer 104 that includes a CPU 106, an I/O unit 108, a memory 110, and a secondary storage computer 112 having a replicated hierarchical data store 124 that communicate with each other via a bus 114. The memory 110 may store a data synchronization system 126 which manages the data synchronization functions of the computer 104 and interacts with the data store 124 as discussed below. The secondary storage 112 may store directory information, recorded data, data to be shared, information pertaining to statistics, user data, multi media files, etc. The data store 124 may also reside elsewhere, such as in memory 110. The computer 104 may also have many of the components mentioned in conjunction with the computer 102. There may be many computers 104 working in conjunction with one another. The data synchronization system 126 may be implemented in any way, in software or hardware or a combination thereof, and may be distributed among many computers. It may also be represented by any number of components, processes, threads, etc.

The computers 102, 104 and 105 may communicate directly or over networks, and may communicate via wired and/or wireless connections, including peer-to-peer wireless networks, or any other method of communication. Communication may be done through any communication protocol, including known and yet to be developed communication protocols. The computers 102, 104 and 105 may also have additional or different components than those shown.

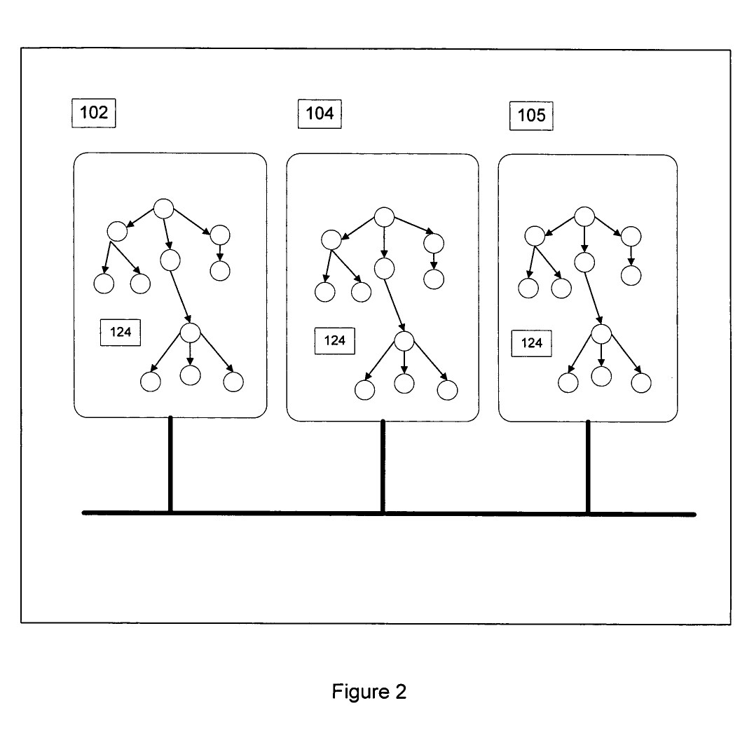

FIG. 2 depicts the logical structure of an exemplary replicated hierarchical data store 124. Each particular instance of the data store 124 is hosted on its respective computer system, 102, 104 and 105. The computers are connected to each other via a communications network that may be a wired connection (such as provided by Ethernet) or a wireless connection (such as provided by 802.11 or Bluetooth). The system may be implemented as a collection of software modules that provide replication of the data store across all instances of the data store as well as providing access to the data store on the local computer 102, 104 and 105.

The replicated data store 124 may be structured as a singly rooted tree of data nodes. When the data store 124 has converged according to the protocol described below, in one implementation, all instances of the data store 124 will be identical with one another both in structure and in content, except for local nodes which may differ from one instance to another. If there is a partition of the network such that, for example, computer 105 is no longer able to communicate with computers 102 and 104 for a period of time, then the data stores in 102/104 and 105 will evolve independently from one another. That is, a user making changes to the data store 124 on computer 105 can make those changes without consulting the system data synchronization 126 on computers 102 and 104. Similarly, users on computers 102 and 104 can make changes to their respective data stores 124 without consulting the data synchronization system 126 on computer 105.

When connectivity is restored amongst all computers 102, 104 and 105, the system propagates the independently made changes across all instances of the data store 124. In those cases where users made conflicting independent changes to the data store 124, these conflicts are resolved on a node-by-node basis. For each node for which there is a conflict, in one implementation, all instances of the data store 124 converge to the value of the node that was most recently modified (for example, in accordance with the description discussed below).

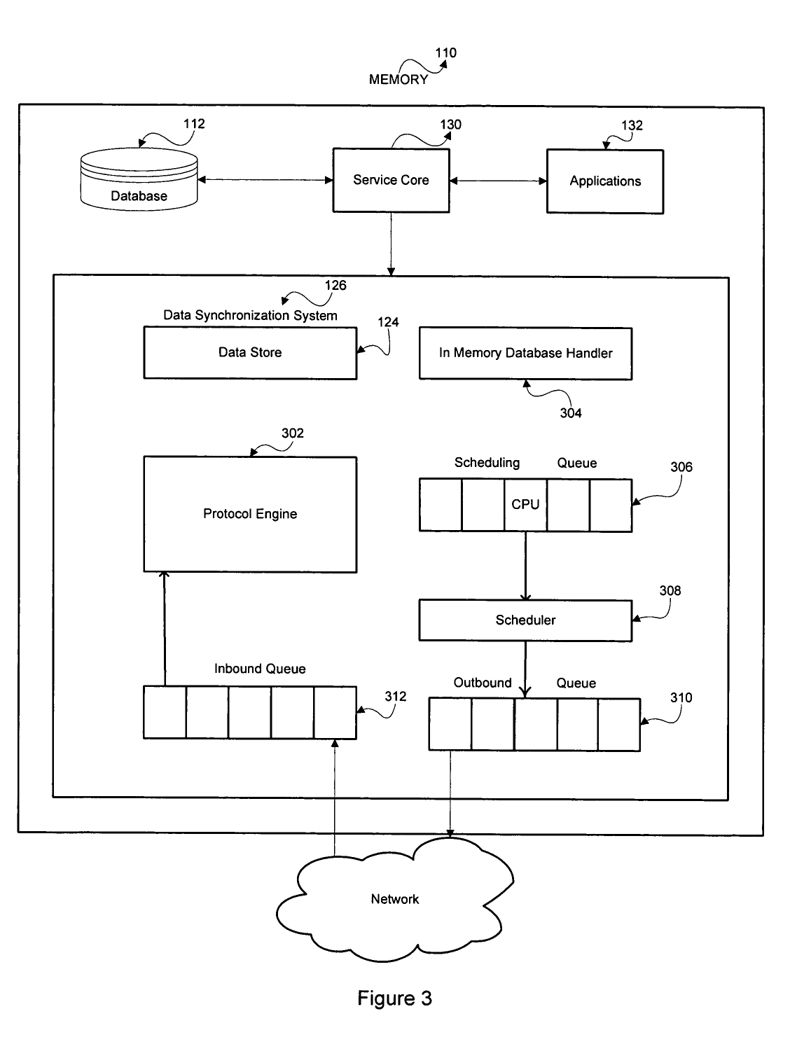

FIG. 3 depicts a block diagram of a data synchronization system 126. Each system 126 may include three exemplary components, a protocol engine 302, a local memory resident version of the data store 124, and a database, which includes both an in-memory component 304 and persistent storage on disk 112, which provides persistent storage associated with computer 102. The protocol engine 302 on each computer 102, 104 and 105 communicates with the protocol engine on other computers 102, 104 and 105 via communication links for the purpose of replicating changes made on one computer system to other computer systems.

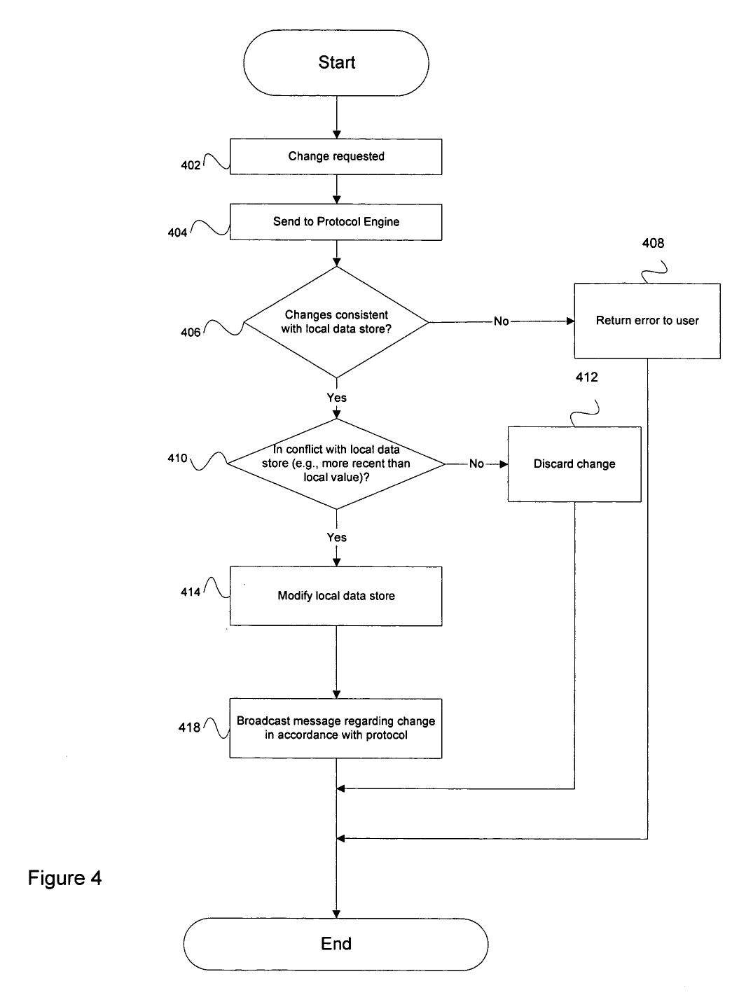

FIG. 4 depicts steps in an exemplary method to change a node in a local data store. For example, to change the value of a node or entry on computer 102 (step 402), an application program 130 communicates the desired change to the data synchronization system 126 using the API's exposed by the system. The data synchronization system 126, in turn, communicates the changes to the protocol engine 302 (step 404). The protocol engine 302 verifies that the local changes are consistent with the local data store (step 406). Consistency, described in detail below, involves whether a change violates integrity constraints on the system. If the change is not consistent with the data store 124, an error is returned to the user (step 408).

If the change is consistent with the data store 124, it is determined whether the change is in conflict with the value in the data store (step 410), and then the memory resident copy of the data store is modified (step 414) if there is conflict. Conflicts in the directory may mean that two or more entities of the directory have made changes in the same location, entry or value within the directory. A change may be in conflict if it is more recent than the local value in the data store 124. The conflicts are resolved by selecting and implementing the most recent modification, i.e., the one with the highest time stamp. If the change is not in conflict, e.g., not more recent than the local data store, the change may be discarded (step 412). On a regular basis, changes to the memory resident data store 124 may be written to persistent storage 112 to ensure that the contents of the data store survive computer reboots and failures. After making changes to the memory resident copy of the data store 124, the protocol engine 302 writes a message to the network containing details of the change made. In one implementation, these messages are broadcast to the network so they will be received by other protocol engines 302 on other computers 102, 104 and 105 (step 418).

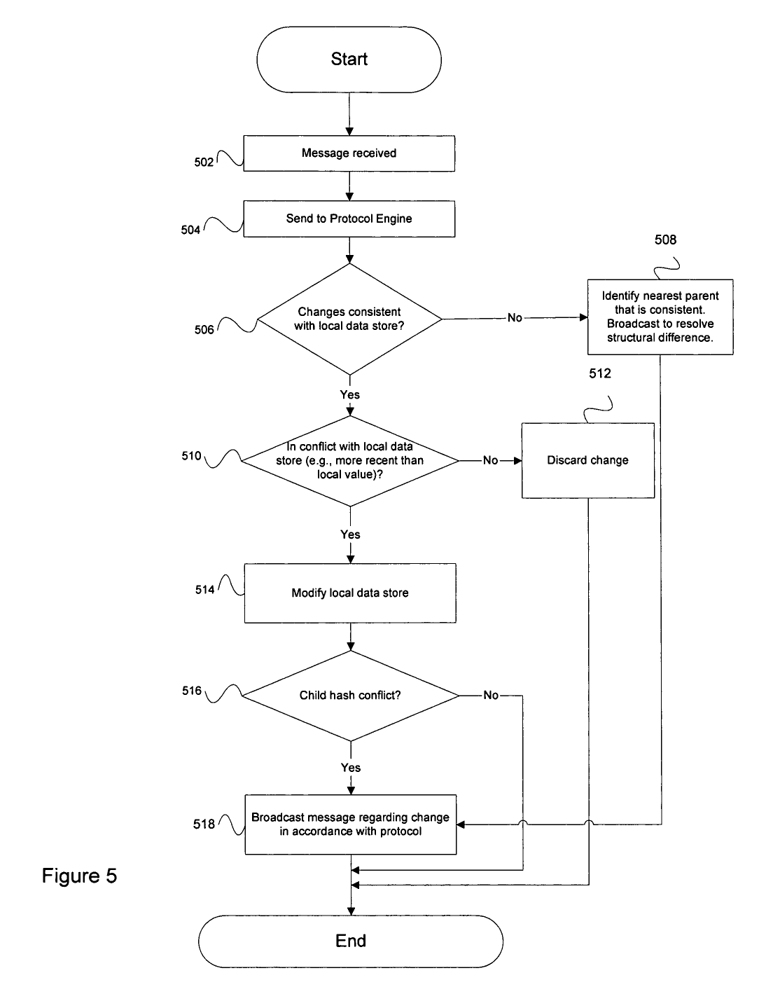

FIG. 5 depicts steps of an exemplary method for processing a received message. On computer 104, for example, this message is received (step 502) and sent to the protocol engine 302 (step 504). The protocol engine 302 verifies that the received changes are consistent with the local data store 124 (step 506). If the change is not consistent with the data store, the protocol engine 302 identifies the nearest parent in the data store that is consistent with the change (508) and broadcasts the state of the nearest parent (step 518) which will notify others and will be used to resolve the structural difference.

The protocol engine 132 then verifies whether the change conflicts with the contents of the local data store 124 (step 510). The most recent modification, i.e., the modification with the highest timestamp, may be selected and implemented. If there is conflict, e.g., the change is more recent than the local data store value, the protocol engine 302 applies the changes to the memory resident data store 124 (step 514). If the change does not conflict, the change may be discarded (step 512). On a regular basis, these changes to the memory resident data store 124 are written to persistent storage 112 to ensure that the contents of the data store survive computer reboots and failures. After modifying the local data store 124, the protocol engine 302 may determine if the child hashes, described below, conflict, e.g., whether the children of the changed node conflict with the message. If so, the children and possibly the parent are broadcast to the rest of the network (step 518) to resolve differences.

In one implementation, methods and systems consistent with the present invention may provide a replicated hierarchical data store 124 that may, in one implementation include the following exemplary features:

The replicated hierarchical data store 124 is a singly rooted tree of nodes.

Each node has a name and value.

The name of a node is specified when it is created and may not be changed thereafter.

The name of the node is a non-empty string.

Each node may have zero or more children nodes.

Each child node is associated with a namespace.

The names of all child nodes within a given namespace are unique.

The namespace is a, possibly empty, string.

The namespace of a child node is specified when that node is created and may not be changed thereafter.

The parent of a node is specified when it is created, and may not be changed thereafter.

Each node may optionally have a value.

This value is represented as a, possibly empty, string.

Nodes may be deleted.

When a node is deleted, all of its child nodes are deleted (the delete operation is applied recursively).

Each node is either “local” or “global.”

Whether a node is local or global is specified when the node is created and may not be changed thereafter.

A local node is one that is only visible only on the computer which created it.

A global node will be replicated to all other data stores on connected computers.

The parent of a global node must be global (hence, the root of the RHDS is global).

When a global node is deleted on one computer, that deletion will be replicated to all other data stores on connected computers.

Each node is either “persistent” or “transient.”

Whether a node is persistent or transient is specified when the node is created and is not changed thereafter.

A persistent node remains accessible from the time it is created until it is explicitly deleted, even across reboots of the computer.

A transient node has a limited lifetime that is specified when the node is created. When the node's lifetime expires, it is deleted. A transient node may be “refreshed,” which extends its lifetime for a specified period. Transient nodes are not preserved across reboots of the computer.

The parent of a persistent node is persistent (hence, the root of the replicated hierarchical data store is persistent).

Each node stores a timestamp indicating when its value was most recently modified.

For a given set of connected computers, the set of values associated with a particular node will converge to the value of the node with the latest timestamp (where timestamps will be considered equivalent if they are within some interval εof each other).

If there are multiple different values associated with the latest timestamp, the set of values will converge to an arbitrary value from the set of latest values.

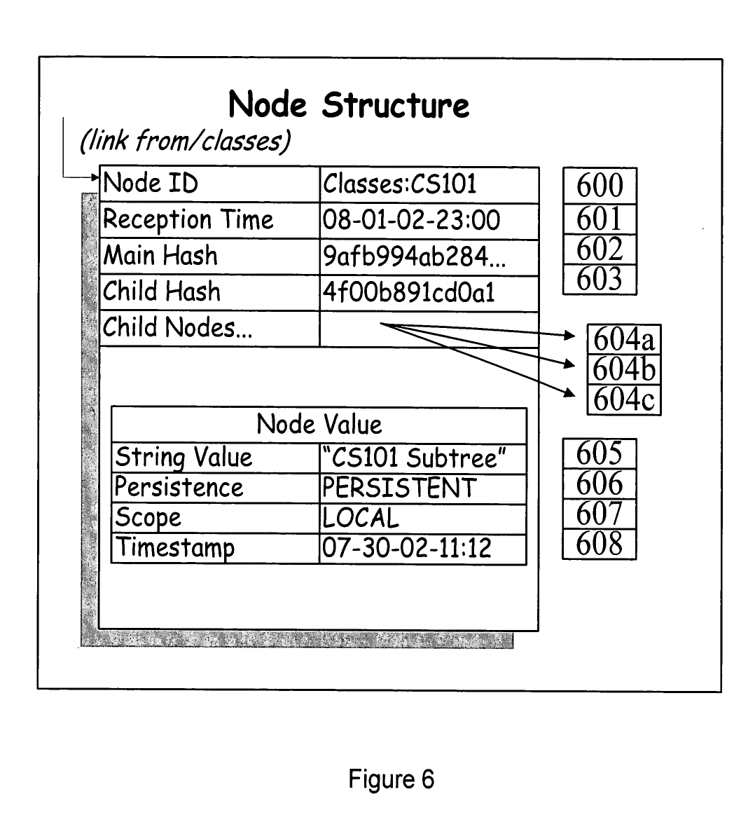

FIG. 6 depicts an exemplary representation of a single node of the data store 124 in one implementation. The node may contain both user-specified data and data which is maintained and used by the data synchronization system 126, in one implementation, to ensure that it adheres to the description discussed previously. Items 600, 605, 606, and 607 are controlled either directly or indirectly through the programming API's of the data store 124. Items 601, 602, 603, 604, and 608 are used internally by the protocol engine 302 and the memory resident version of the data store 124.

The node ID 602 may be specified by the user when the node is created. The node's ID 602 may be composed of its namespace, followed by a colon, followed by the name of the node.

The reception time 601 is the reception time of the node. This is the time (for example, measured in milliseconds) when the node was first received by the protocol engine 302. Time stamp 608 is a timestamp indicating when the value of the node was last changed. In the case in which a node is modified locally through programmatic API's, the timestamp 608 and the reception time 601 will be identical.

Main hash 602 may be a hash value, which is a 64-bit integer value, for example, computed as a function of the node ID 600, the node value 605, and the child hash 603. The hash function has been designed such that if the hash values of a pair of nodes are equal, then, with very high probability, the values used to compute the hash are equal. Child hash 503 may be a child hash, which is computed by combining together the main hash values of all of the (non-local) children of the node.

Child references 604 is a set of references to children of this node. Value 605 is the value of the node, which can be changed over the lifetime of the node through programmatic API's. Persistent flag 607 is a flag indicating whether the node is persistent or transient. This flag 606 is set when the node is created and, in one implementation, cannot be modified by the user subsequently. Local flag 607 is a flag indicating whether the node is local or global. This flag is set when the node is created and, in one implementation, cannot be modified by the user subsequently.

Referring back to FIG. 3, further detail on data synchronization system 126 is provided. As noted in the description discussed previously, one exemplary purpose of the system software may be to implement a hierarchical data store 124 that is replicated over a set of participating computer systems 102, 104 and 105. The data synchronization system 126 provides a means for the contents of the store to be created, modified, inspected, and deleted by other applications 132 running on the computer 102. For the data store 124, this is satisfied by the existence of a programming API that provides for the creation, modification, inspection, and deletion of nodes within the tree. Requests to inspect a particular node of the tree are satisfied by accessing the corresponding node within the local data store 124. The creation, modification, and deletion of nodes, however, in one implementation, cannot be realized solely through actions on the local data store. In order to ensure that all local data stores 124 on participating computers 102, 104 and 105 converge to the same state, operations that change the state of the data store are transmitted, in one implementation, to all of the participating computers. Thus, modifications to the data store 124 on each computer can originate, for example, in one of two ways: (1) the data store can be modified as the result of actions taken through the local programming API, and (2) the data store can be modified as the result of actions taken through the programming API on another computer, and relayed to the local computer over the network.

One element of the data synchronization system 126 may be an algorithm that defines how data store changes are relayed from one computer to another. The relaying of information from one computer to another occurs through the sending and receiving of “messages.” The algorithm, for example, defines: (1) how the local data store is modified as the result of receiving a particular message, and (2) when messages need to be sent to other computers, and what the contents of those messages should be.

This algorithm is referred to as the “directory protocol.” The protocol engine 302 may be the software component that implements the directory protocol. In order to simplify the implementation of the replicated hierarchical data store 124, in one implementation, changes made to the data store via the local programming API are actually converted into messages by the service core 130 and then submitted to the protocol engine 302. Thus, the protocol engine 302, in one implementation, mediates all changes to the data store 124.

The directory protocol can be expressed in a formal manner by defining the structure of the data store 124, the structure of directory protocol messages, and the actions undertaken upon receipt of a message. The protocol engine 302 may be a realization in software of this formal specification. The remaining components identified in FIG. 3 (the inbound queue 312, the outbound queue 310, and the scheduling queue 306) exist primarily to ensure adequate performance of the software system.

The local data store 124 may be a singly rooted tree that can be recursively defined as:

T=<ns, id, s, d, 1, g, t, r, hₘ, h_{c}, c

where

ns ε Σ* [the namespace of the node]

nm ε Σ* [the name of the node]

s ε Σ* [the value of the node]

d ε {true, false} [indicates whether the node is deleted]

1 ε {persistent, transient}

g ε {local, global}

t=timestamp of the most recent modification to the node

r=timestamp when this node was received

hₘ=main hash of the node

h_{c}=child hash of the node

c={c₁, c₂ . . . cₙ} is the ordered sequence of children of the node

Σ* is the set of all, possibly null, strings

The individual components of a node n will be referred to as n.ns, n.nm, etc. The children of a node may satisfy the uniqueness constraint that for a given node n, and a given child of that node, n.cᵢ, there is no other child of n, n.cₖ, such that n.cᵢ.ns=n.cₖ.ns and n.cᵢ.nm=n.cₖ.nm. Since the tree is singly rooted, and all child nodes are named uniquely, each node is associated with a unique “path” that completely describes its position within the tree. That path may have the form:/root/ns₁:nm₁/ns₂:nm₂/ . . . /nsₖ:nmₖ, where “root” is the predefined name of the root node, and the nsᵢ:nmᵢ are the set of nodes encountered on a traversal of the tree starting at the root and ending at the node in question. For each node n in the tree, its path is defined as:

P(n)=path to node n

Each node may contain two hash values hₘ and h_{c}. The first, the main hash 602, may be computed over those elements of the node's state that are controlled via the programming API's and recursively includes the hash values of the node's children:

Ψₘ(n)=Φ(Ψₛ(P(n), Ψₛ(n.s), Ψ_{b}(n.d), Ψ_{b}(n.l), Ψ_{b}(n.g), n.t, n.c₁.hₘ, . . . n.cₖ.hₘ)

where

Ψₛ is a hash function from strings to 64-bit integers

Ψ_{b} is a function that converts two state flags into integer values 0 and 1 Φ is a hash function that combines a set of 64-bit integers into a single 64-bit integer (this hash function has particular properties noted below).

A property of this hash function is that given two nodes n₁ and n₂, if Ψₘ(n₁)=Ψₘ(n₂), then there is a high probability that n₁ and n₂ represent identical sub-trees. This property is useful in the context of the directory protocol because it allows entire sub-trees to be compared with each other by simply comparing hash values. Due to the probabilistic nature of the hash function, however, additional safeguards described below are utilized to detect when such hash collisions have occurred.

The child hash 603 may simply be the combination of the main hashes 602 from each of the node's non-local children:

Ψ_{c}(n)=Φ(n.c₁.hₘ, . . . n.cₖ.hₘ) or 0 if n has no children

As with the main hash 602, the child hash 603 helps to probabilistically compare the sub-trees associated with the children of a particular node. That is, if Ψ_{c}(n₁)=Ψ_{c}(n₂) then, with very high probability, n₁ and n₂ have identical sets of child sub-trees. Furthermore, if Ψₘ(n₁)≠Ψₘ(n₂) and Ψ_{c}(n₁)=Ψ_{c}(n₂), then, with high probability, n₁ and n₂ have different values for at least one of the fields ns, nm, d, l, g, or t (that is, a difference that is local to the nodes themselves, and not associated with the sub-trees rooted at the nodes).

The directory protocol, in one implementation, operates through the exchange amongst peer directory instances, of a single type of message. Messages may be derived from nodes, and the format of this message may be:

M=<p, s, d, l, g, t, h_{c}, c>

where

p is the path of the node

s is the value of the node

d indicates whether the node is deleted

l indicates whether the node is persistent or transient

g indicates whether the node is local or global

t is the modification time of the node

h_{c} is the child hash of the node

c is the time at which the message is sent

A message may, thus, be generated from a node as follows:

M(n)=<P(n), n.s, n.d, n.l n.g, n.t, n.h_{c}, T>

where

n is a node whose state is to be sent out

T is the time at which the message is sent

The messages that are exchanged amongst peer directory instances may be basically a serialization of the value of a given node, not including the values of its child nodes.

In one implementation, the bulk of the directory protocol comprises the specification of how to handle incoming messages. In the process of handling these messages, the directory protocol will sometimes transmit messages as well. Typically, these messages are not sent immediately, but are scheduled for transmission at some point in the future. This deferred transmission of messages is handled by the scheduling queue 306 and scheduler 308, which will be referred to in the protocol description as “Q.” In one implementation, this scheduling queue 306 supports two operations:

Push(n, d)—This causes the scheduling queue 306 to transmit the message M(n) at a point d milliseconds from the current time.

Clear(p)—This causes the scheduling queue 306 to remove all pending messages sends, mᵢ, for which mⱼ.p=p.

A back-off function, in one implementation, determines the delay used when pushing a node onto the scheduling queue 306. The purpose of the back-off function is to ensure that the most recently modified version of a node is transmitted first (as will become clear from the protocol description, many computers will schedule the transmission of a given node at roughly the same time. The backoff function determines which of those messages will actually be transmitted first). This is not necessary for the correctness of the protocol, but it does improve its performance. The back-off function is based on both the modification time and the receipt time of a given node:

B(n)=β(n.t, n.r)

In handling incoming messages, the directory protocol also accesses the state of the local directory in several ways:

T_{recv}(m)—The current time on the receiving machine at the moment message m is received.

Exists(p)—A Boolean function indicating whether the given path corresponds to a node in the local data store 124.

Node(p)—A function that returns the node from the local data store 124 corresponding to the given path.

ParentExists(p)—A Boolean function indicating whether the given path has a node which could act as its parent in the local data store 124.

ParentNode(p)—A function that returns the node that is the parent for the given path in the local data store 124.

Ancestor(p)—A function that returns the node that is the nearest ancestor in the local data store 124 for the given path.

When the tree is incomplete with respect to a give node, that node may not have a parent (i.e., ParentNode(p) returns a null object). Ancestor(p) gives the closest node which actually exists within a given directory tree, which would be an ancestor of the node indicated by p, if p were to actually exist. If ParentNode(p)<> Null then ParentNode(p)==Ancestor(p).

There is also one additional parameter that controls some aspects of the protocol's behavior:

δ—The allowable clock drift between machines. The smaller this value, the more accurately the directory is able to track changes. However, a small value for δ also means that the computers participating in the directory protocol should have their clocks synchronized within this bound.

Finally, the directory protocol may also make use of a function, Consistent(p), that determines whether a received message is consistent with the state of the local data store 124. In one implementation, a subset of the description as discussed previously constrains the attributes of the nodes within the tree. For example, the parent of a persistent node is persistent. The protocol assumes that all peer directories have a root node which is both “persistent” and “global.”

Suppose that a message m is received which refers to a node n in the local data store 124. If m.l=persistent, but ParentNode(m.p).l=transient, then message m is said to be inconsistent with respect to the local data store 124 because updating node n to reflect the state of message m would result in a local data store that violated the integrity constraints specified in the description. This sort of consistency issue is associated with the attributes n.d, n.l, and n.g. (Remove/Not Removed, Persistent/Transient and Local/Global). Inconsistency may mean that the local directory and a remote directory disagree about the attributes of a node or sub-tree of nodes. For example, the local directory may believe that a node is transient but receive a network message indicating that a child of that node is persistent. This may violate an integrity constraint on the directory. However, this situation can occur when local and remote directories make independent changes to the attributes of nodes. These inconsistencies are resolved much as differences in the node values are by looking for the most recent changes and creating a consistent tree based on those.

The receipt of a message whose contents are inconsistent with the local data store 124 indicates that the local data store and that of the host from which the message originated are structurally different. To resolve these structural differences, the two hosts identify the point in the tree at which the structural divergence originates and converge the state of their two trees starting at that point. It will be seen from the protocol description that, in one implementation, this does not require any special messages or processing beyond the detection of the inconsistency.

The directory protocol is initiated through the receipt of a message m. For each such a message, the protocol includes executing the sequence of operations shown in the “Directory Algorithm” below. In addition to executing this protocol, the replicated hierarchical data store 124 may rely on several other components, such as the outbound, inbound and scheduling queues, 304, 306 and 310 and constraints to ensure that the system achieves an acceptable level of performance in terms of factors such as the number of messages exchanged and the average amount of time required to synchronize a single node across a set of connected machines. In one implementation, the Directory Algorithm is as follows:

Directory Algorithm

```
If | T_{recv}(m)- m.c | > δ
  Ignore message m
Else If Exists(m.p)
  If Consistent(m)
      If m.t > Node(m.p).t
        Update Node(m.p) with state from m
        Make subtree at Node(m.p) consistent
        Q.Clear( m.p )
      Else
        Q.Push( Node(m.p), B(Node(m.p)) )
  Else
      Q.Push( ParentNode(m.p), B(ParentNode(m.p)) )
Else If ParentExists(m.p)
  If Consistent(m)
      Create local node n based on state from m
  Else
      Q.Push( ParentNode(m.p), B(ParentNode(m.p)) )
Else
  Q.Push( Ancestor(m.p), B(Ancestor(m.p)) )
If data store modified
  Recalculate hₘ and h_{c} for the modified node and all its
  ancestors
If Exists(m.p) and m.hc ≠ Node(m.p).h_{c}
  Q.Push( Node(m.p), B(Node(m.p)) )
  For each child node n of Node(m.p)
    Q.Push( n, B(n) )
```

As noted previously, the scheduling queue 306 is used to control when messages are sent out. Each message that is placed in the queue 306 is associated with the time at which it should be delivered. The scheduler 308 is responsible for tracking the time at which the next message should be delivered and removing it from the scheduling queue 306. After being removed from the scheduling queue 306, the message is placed into the outbound queue 310 where it will wait until the network is ready to transmit it. There may be a single thread of control responsible for removing messages from the outbound queue 310 and transmitting them via the networking layer. This ensures that messages are transmitted in the order in which they are placed into the outbound queue 310.

The inbound queue 304 serves a similar purpose. As the network layer receives messages, they are placed into the inbound queue 304. There may be a single thread of control that is responsible for removing messages from the inbound queue 304 and delivering them to the protocol engine 302 for processing. The inbound queue 304 provides buffering so that the system as a whole can handle transient situations in which the rate of arrival of messages from the network exceeds the rate at which they can be processed by the protocol engine 302. If the inbound message rate were to exceed the servicing rate for an extended period of time, the buffer capacity may be exceeded, and some messages may need to be dropped.

Whenever the size of the inbound queue 312 is greater than zero, in one implementation, the scheduler 308 is prevented from advancing the deadlines of any messages in the scheduling queue 306. The purpose of this constraint is to ensure that any inbound message has the opportunity to cancel out messages that are held in the scheduling queue 306. Cancelling out occurs when a message arrives from the network and is used to update the local data store 124. In one implementation, the local data store 124 is only updated when the message contains data that is more up to date. However, the scheduling queue 306 may contain messages that were derived from the older information in the data store 124. It may not make sense to transmit this out of date information. The cancelling operation can be seen in the protocol specification where if a message is used to update the local data store 124, then, in one implementation, all messages with that path are removed from the scheduling queue 306. This cancelling operation helps reduce the number of message exchanges that are required to synchronize the data stores 124.

Another performance enhancement is achieved by sending multiple messages at once. A single message may be typically small, for example, on the order 100 to 200 bytes in size. The network environments in which the software operate, may generally transmit data in units of approximately 1500 bytes, commonly referred to as a “packet.” As there may be a fixed overhead in both time and space associated with transmitting a packet, it may be efficient to ensure that each packet includes as many messages as possible. This is achieved by having the scheduler 308 remove several messages from the scheduling queue 306 whenever the deadline for transmission of a message arrives. This results in some messages being transmitted before their scheduled deadlines. Sending a message before its deadline removes some of the opportunities for cancelling out messages. The longer a message is in the scheduling queue 306, the more opportunity there is for a message to arrive from the network and cancel it out. This loss of message cancellation may be more than offset by the increase in efficiency achieved by sending messages in batches.

Batching of messages may require some small changes in the protocol engine 302. First, when a message batch is processed, it helps to ensure that the nodes are dealt with in top down traversal order. Suppose that the batch contains messages m₁ and m₂ such that Node(m₁.p)=ParentNode(m₂.p). Then, the processing of m₁ should occur before m₂. Second, the recalculation of the hash values should be delayed until all of the messages have been either discarded or merged into the local data store 124. In both cases, these changes are not necessary for correctness, but they make a substantial improvement in the performance of the system.

Because the system aggressively replicates data, it is possible for the amount of data stored locally to grow very large. Not all of this information will be useful to the applications that are built on top of the replicated hierarchical data store 124. In order to reduce local memory requirements a new node state, “pruned/not pruned,” is introduced. When a node is marked as pruned, in one implementation, all of its children are removed from the local data store 124. The value of the child hash (n.h_{c}) 603 is set to be either the last computed value of the child hash prior to the node being marked pruned, or the last child hash value contained in a message from the network corresponding to this node (if a such a message has arrived since the node was marked pruned).

As discussed previously, in one implementation, the directory protocol may function more efficiently when the system clocks of the participating computers are synchronized to within a value of δ of one another. In order to ensure this, the replicated hierarchical data store 124 implements a heuristic designed to ensure that a connected group of machines will eventually all have clocks that are synchronized within the desired bound. Unlike conventional clock synchronization algorithms (e.g., Network Time Protocol), the clock heuristic used in the replicated hierarchical data store 124 does not require the participants to agree in advance on a clock master, that is, a particular computer whose clock is assumed to be authoritative.

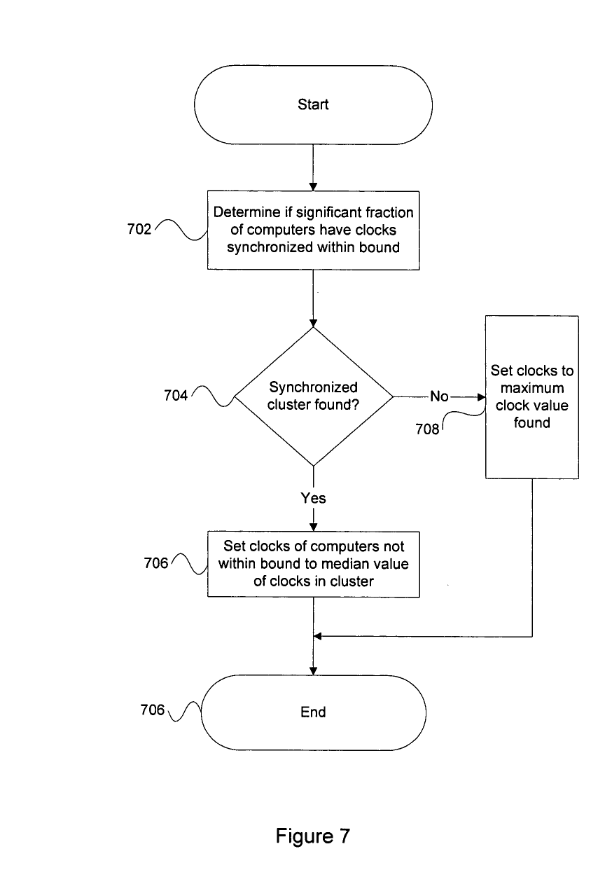

FIG. 7 depicts steps in an exemplary method for synchronizing clocks in accordance with methods and systems consistent with the present invention. The replicated hierarchical data store clock synchronization protocol may work in two stages. First, it attempts to determine if a significant fraction of the connected computers have clocks that are synchronized within the desired bound (step 702). If such a cluster of synchronized computers can be found (step 704), then a computer whose clock is not within that bound will set the local clock to the median value of the clocks in that group (step 706). Second, if it cannot find such a cluster of computers, it will set the local clock to be the maximum clock value that it has observed (step 708).

In order to implement this protocol, the replicated hierarchical data store examines each incoming message and extracts m.c, the time at which the message was sent (in the frame of reference of the sending computer). It is assumed that the transmission time for a message is negligible (which may be true for the local area networks), and thus the difference between the local clock and that of the sending computer is:

T_{cum}(m)−m.c

The replicated hierarchical data store implementation maintains a table that associates a clock difference with each computer from which a directory message has been received. This table is used to identify the clusters of machines whose clocks lie within the δ-bound of each other. The clusters are defined by simply dividing the time interval from the lowest to the highest clock value into intervals of length 6.

When a message arrives such that |T_{curr}(m)−m.c|>δ, the local replicated hierarchical data store computes the current set of clock clusters and determines whether it is in the largest one. If it is not, it assumes that the local clock value should be changed. If no clusters can be identified, then the largest observed clock value is used.

Execution of this clock protocol helps ensure that all connected computers will have clocks that lie within a δ-bound of each other, and therefore will be able to efficiently execute the synchronization protocol. Furthermore, if most of the computers are in rough agreement about the current time, then only the outlying machines will modify their local clock values. This may be desirable since most computers may have their clocks set correctly for the local time zone, and the clock synchronization heuristics will not modify these.

It is noted that the above elements of the above examples may be at least partially realized as software and/or hardware. Further, it is noted that a computer-readable medium may be provided having a program embodied thereon, where the program is to make a computer or system of data processing computers execute functions or operations of the features and elements of the above described examples. A computer-readable medium may include a magnetic or optical or other tangible medium on which a program is embodied, but can also be a signal, (e.g., analog or digital), electromagnetic or optical, in which the program is embodied for transmission. Further, a computer program product may be provided comprising the computer-readable medium.

The foregoing description of an implementation in accordance with the present invention has been presented for purposes of illustration and description. It is not exhaustive and is not limited to the precise form disclosed. Modifications and variations are possible in light of the above teachings or may be acquired from practice. For example, the described implementation includes software but methods in accordance with the present invention may be implemented as a combination of hardware and software or in hardware alone. Note also that the implementation may vary between systems. Methods and systems in accordance with the present invention may be implemented with both object-oriented and non-object-oriented programming systems.

1. A method in a data processing system having peer-to-peer replicated data stores, comprising:
receiving, by a first data store, a plurality of values sent from a plurality of other data stores; and
updating a value in the first data store based on one or more of the received values for replication.

2. The method of claim 1, wherein the values that are sent from a plurality of other data stores are broadcast from the plurality of other data stores to another plurality of data stores.

3. The method of claim 1, wherein the first data store is a hierarchical replicated data store.

4. The method of claim 1, further comprising the step of:
determining if a value received from one of the plurality of other data stores is consistent with the value of the first data store.

5. The method of claim 4, further comprising the steps of:
identifying the difference between the first data store and the data store from which the value was received if they are not consistent; and
reconciling the first data store and the data store from which the value was received.

6. The method of claim 5, wherein the reconciling further comprises the step of:
updating the least recent data store at the point of the identified difference based on the most recent data store.

7. A method in a data processing system having a first data store and a plurality of other data stores, the first data store having a plurality of entries, each entry having a value, the method comprising the steps of:
receiving by the first data store a plurality of values from the other data stores for one of the entries;
determining by the first data store which of the values is an appropriate value for the one entry; and
storing the appropriate value in the one entry to accomplish replication.

8. The method of claim 7, wherein the determining step further comprises the step of:
determining which of the values is a most recently stored value.

9. The method of claim 7, further comprising the step of:
broadcasting the plurality of values from the other data stores to another plurality of data stores.

10. A data processing system having peer-to-peer replicated data stores, comprising:
a memory comprising program instructions that receive, by a first data store, a plurality of values sent from a plurality of other data stores, and update a value in the first data store based on one or more of the received values for replication; and
a processor for running the program.

11. The data processing system of claim 10, wherein the values that are sent from a plurality of other data stores are broadcast from the plurality of other data stores to another plurality of data stores.

12. The data processing system of claim 10, wherein the first data store is a hierarchical replicated data store.

13. The data processing system of claim 10, wherein the program further determines if a value received from one of the plurality of other data stores is consistent with the value of the first data store.

14. The data processing system of claim 13, wherein the program further identifies the difference between the first data store and the data store from which the value was received if they are not consistent, and reconciles the first data store and the data store from which the value was received.

15. The data processing system of claim 14, wherein the reconciling further comprises the step of:
updating the least recent data store at the point of the identified difference based on the most recent data store.

16. A data processing system having a first data store and a plurality of other data stores, the first data store having a plurality of entries, each entry having a value, the data processing system comprising:
a memory comprising a program that receives by the first data store a plurality of values from the other data stores for one of the entries, determines by the first data store which of the values is an appropriate value for the one entry, and stores the appropriate value in the one entry to accomplish replication; and
a processor for running the program.

17. The data processing system of claim 16, wherein the program further determines which of the values is a most recently stored value.

18. The data processing system of claim 16, wherein the program further broadcasts the plurality of values from the other data stores to another plurality of data stores.

19. A computer-readable medium containing instructions for controlling a data processing system having peer-to-peer replicated data stores to perform a method comprising the steps of:
receiving, by a first data store, a plurality of values sent from a plurality of other data stores; and
updating a value in the first data store based on one or more of the received values for replication.

20. The computer-readable medium of claim 19, wherein the values that are sent from a plurality of other data stores are broadcast from the plurality of other data stores to another plurality of data stores.

21. The computer-readable medium of claim 19, wherein the first data store is a hierarchical replicated data store.

22. The computer-readable medium of claim 19, where in the method further comprises the step of:
determining if a value received from one of the plurality of other data stores is consistent with the value of the first data store.

23. The computer-readable medium of claim 22, where in the method further comprises the steps of:
identifying the difference between the first data store and the data store from which the value was received if they are not consistent; and
reconciling the first data store and the data store from which the value was received.

24. The computer-readable medium of claim 23, wherein the reconciling further comprises the step of:
updating the least recent data store at the point of the identified difference based on the most recent data store.

25. A computer-readable medium containing instructions for controlling a data processing system to perform a method, the data processing system having a first data store and a plurality of other data stores, the first data store having a plurality of entries, each entry having a value, the method comprising the steps of:
receiving by the first data store a plurality of values from the other data stores for one of the entries;
determining by the first data store which of the values is an appropriate value for the one entry; and
storing the appropriate value in the one entry to accomplish replication.

26. The computer-readable medium of claim 25, wherein the determining step further comprises the step of:
determining which of the values is a most recently stored value.

27. The computer-readable medium of claim 26, wherein the method further comprises the step of:
broadcasting the plurality of values from the other data stores to another plurality of data stores.

28. A data processing system having peer-to-peer replicated data stores, comprising:
means for receiving, by a first data store, a plurality of values sent from a plurality of other data stores; and
means for updating a value in the first data store based on one or more of the received values for replication.
